(19) United States
(12) Patent Application Publication
(10) Pub. No.: US 2018/0023834 A1
(43) Pub. Date: Jan. 25, 2018

(54) EFFICIENT MANAGEMENT OF INDOOR CONDITIONS

(71) Applicant: Vivint, Inc., Provo, UT (US)

(72) Inventors: Brandon Gordon Hatch, Provo, UT (US); Jeffrey David Whitlock, Provo, UT (US); Bryan Brothers, Springville, UT (US)

(21) Appl. No.: 15/215,095

(22) Filed: Jul. 20, 2016

(51) Int. Cl. F24F 11/00; H04L 12/28

(52) U.S. Cl. CPC F24F 11/0012; F24F 11/0086; H04L 12/2816; G05B 2219/2614; F24F 2011/0013; F24F 2011/0019

(57) ABSTRACT

The present disclosure relates to efficiently managing indoor conditions. Efficient management comprises opening barriers to openings to a building to reduce the use of a heating, ventilation and cooling (HVAC) system. Reducing the use of an HVAC system may reduce monetary costs to a user of the HVAC system and reduce consumption of energy resources. In one embodiment, a method for security and/or automation systems efficiently managing indoor environmental conditions may comprise monitoring one or more outdoor environmental conditions via one or more outdoor sensors. One or more indoor environmental conditions may be monitored via one or more indoor sensors. It may be determined when to adjust one or more barriers to a building based at least in part on the monitoring to achieve one or more indoor environmental thresholds.

### BACKGROUND

The present disclosure, for example, relates to security and/or automation systems, and more particularly to manipulating various windows, doors, and other barriers/openings to a structure or building to efficiently achieve desirable indoor conditions.

Security and automation systems are widely deployed to provide various types of communication and functional features such as monitoring, communication, notification, and/or others. These systems may be capable of supporting communication with a user through a communication connection or a system management action.

Heating, ventilation, and air conditioning (HVAC) systems are used to achieve optimal indoor conditions. The HVAC systems may adjust indoor conditions to differ from outdoor conditions. However, operating the HVAC system is very energy intensive. The amount of energy consumed by HVAC systems can be very costly, both monetarily and environmentally.

### SUMMARY

The present disclosure may relate to efficiently managing indoor conditions. Efficient management may comprise opening one or more barriers to one or more openings to a building to reduce the use of a heating, ventilation and cooling (HVAC) system. The one or more barriers may comprise a window, door, hatch, entry way, and the like. Reducing the use of an HVAC system may reduce monetary costs to a user of the HVAC system and reduce consumption of energy resources.

In one embodiment, a method for security and/or automation systems may comprise monitoring one or more outdoor environmental conditions via one or more outdoor sensors. One or more indoor environmental conditions may be monitored via one or more indoor sensors. The method may include determining when to adjust one or more barriers to a building based at least in part on the monitoring to achieve one or more indoor environmental thresholds.

In some instances, one or more barriers may be adjusted based at least in part on the determining. Additionally, a user of the automation system may be alerted to adjust one or more barriers based at least in part on the determining. A user of an automation system may be alerted to adjust one or more HVAC settings based at least in part on the determining and the adjusting. An approximate energy savings may be calculated based at least in part on the adjusting. In some instances, a user of an automation system may be notified to adjust one or more barriers to the building based at least in part on the determining. The notifications may comprise energy saving information.

In some embodiments, one or more barrier coverings may be adjusted based at least in part on the determining. The one or more outdoor environmental conditions may comprise one of at least temperature, wind speed, wind direction, air quality, humidity, precipitation, and noise. In some instances, it may be determined if the air quality or noise level satisfy one or more thresholds; and one or more barriers to a building may be closed based on the determining.

In some embodiments, the one or more outdoor environmental conditions may comprise a threshold to satisfy to either open or close the one or more barriers. Each environmental condition may be weighted and the threshold for the highest weighted environmental condition make take precedent over a lower weighted environmental condition. In some embodiments, a length of time to achieve a desired indoor environmental condition may be calculated based at least in part on the monitoring and an approximate energy savings may be gauged based at least in part on the calculating.

In alternative embodiments, an apparatus for security and/or automation systems is described. The apparatus may comprise a processor, memory in electronic communication with the processor; and instructions stored in the memory. The instructions may be executable by the processor to monitor one or more outdoor environmental conditions via one or more outdoor sensors. The instructions may be executable by the processor to monitor one or more indoor environmental conditions via one or more indoor sensors and determine when to adjust one or more barriers to a building based at least in part on the monitoring to achieve one or more indoor environmental thresholds.

In further embodiments, a non-transitory computer-readable medium storing computer-executable code for wireless communication is disclosed. The code may be executable by a processor to monitor one or more outdoor environmental conditions via one or more outdoor sensors. The code may be executable by the processor to monitor one or more indoor environmental conditions via one or more indoor sensors and determine when to adjust one or more barriers to a building based at least in part on the monitoring to achieve one or more indoor environmental thresholds.

The foregoing has outlined rather broadly the features and technical advantages of examples according to this disclosure so that the following detailed description may be better understood. Additional features and advantages will be described below. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein—including their organization and method of operation—together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following a first reference label with a dash and a second label that may distinguish among the similar components. However, features discussed for various components—including those having a dash and a second reference label—apply to other similar components. If only the first reference label is used in the specification, the description is applicable to any one of the similar components having the same first reference label irrespective of the second reference label.

FIG. 1 shows a block diagram relating to a security and/or an automation system, in accordance with various aspects of this disclosure;

FIG. 2 shows a block diagram of a device relating to efficient indoor environmental management, in accordance with various aspects of this disclosure;

FIG. 3 shows a block diagram of a device relating to efficient indoor environmental management, in accordance with various aspects of this disclosure;

FIG. 4 shows a block diagram relating to efficient indoor environmental management, in accordance with various aspects of this disclosure;

FIG. 5 shows a swim diagram illustrating communications of efficient indoor environmental management, in accordance with various aspects of this disclosure;

FIG. 6 is a flow chart illustrating an example of efficient indoor environmental management, in accordance with various aspects of this disclosure; and

FIG. 7 is a flow chart illustrating an example of efficient indoor environmental management, in accordance with various aspects of this disclosure.

### DETAILED DESCRIPTION

Depending upon different environmental conditions, equipment, and building size among other factors, HVAC costs may accumulate to a sizable monetary sum. Operating an HVAC system may cost hundreds and sometimes thousands of dollars over the course of a year. Likewise, businesses may exceed that amount by keeping their buildings at a comfortable indoor condition for clients, customers, goods, employees, and the like. Some people attempt to open windows or other barriers to regulate the indoor conditions; however it is not always fool proof and can be cumbersome. Homes may get too hot or too cold, a home owner may forget to close a window if it rains, etc. The windows need to be shut for security purposes or sometimes open windows may overcorrect the indoor environment to the discomfort of building inhabitants.

Automating the adjustment of one or more barriers to openings of a building may aid in regulating indoor conditions to achieve a desirable indoor temperature and reduce the use of an HVAC system, thus reducing energy costs, while also alleviating personnel from manually opening and closing the barriers. The barriers may consist of one or more of a window, door, skylight, hatch, gate, portal, and the like. Automating the adjustment of the barriers to a building may require monitoring outdoor and indoor conditions, setting optimal indoor conditions, and optimizing the system to achieve those conditions. The conditions may relate to airing out a home, noise level, air quality, pollution level, precipitation, humidity, dryness, temperature and the like.

The following description provides examples and is not limiting of the scope, applicability, and/or examples set forth in the claims. Changes may be made in the function and/or arrangement of elements discussed without departing from the scope of the disclosure. Various examples may omit, substitute, and/or add various procedures and/or components as appropriate. For instance, the methods described may be performed in an order different from that described, and/or various steps may be added, omitted, and/or combined. Also, features described with respect to some examples may be combined in other examples.

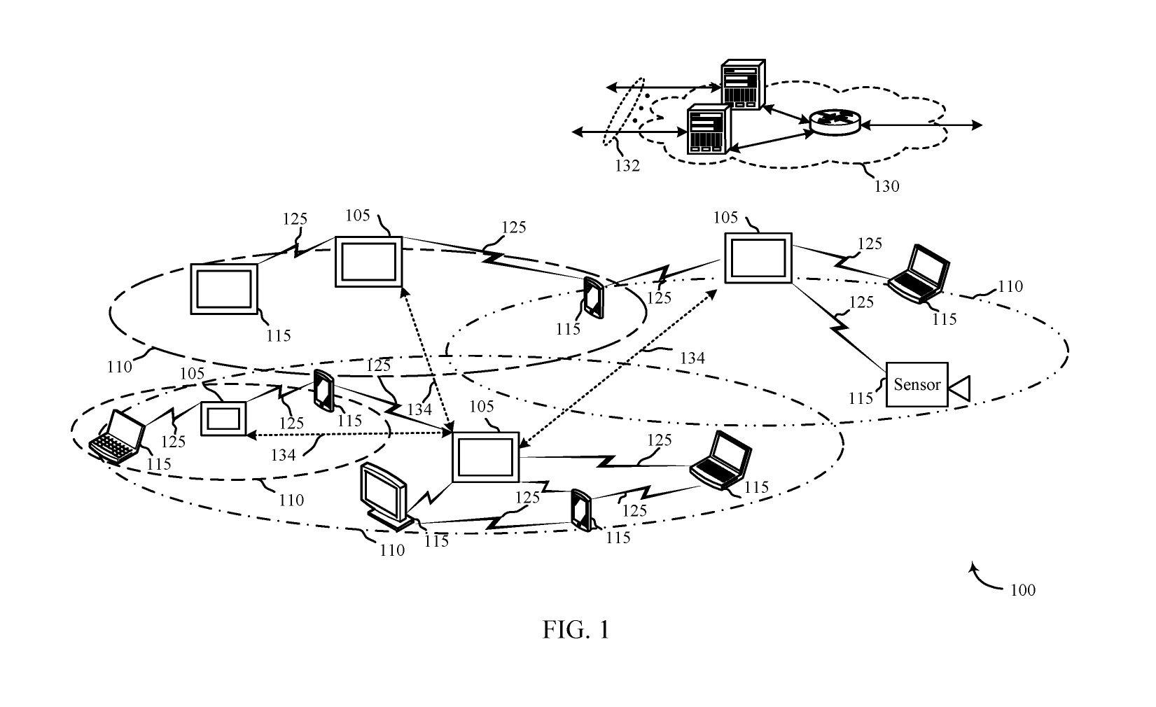

FIG. 1 illustrates an example of a communications system 100 in accordance with various aspects of the disclosure. The communications system 100 may include control panels 105, devices 115, and/or a network 130. The network 130 may provide user authentication, encryption, access authorization, tracking, Internet Protocol (IP) connectivity, and other access, calculation, modification, and/or functions. The control panels 105 may interface with the network 130 through wired and/or wireless communication links 132 and may perform communication configuration, adjustment, and/or scheduling for communication with the devices 115, or may operate under the control of a controller. In various examples, the control panels 105 may communicate—either directly or indirectly (e.g., through network 130)—with each other over wired and/or wireless communication links 134. Control panels 105 may communicate with a back end server—directly and/or indirectly—using one or more communication links.

The control panels 105 may wirelessly communicate with the devices 115 via one or more antennas. Each of the control panels 105 may provide communication coverage for a respective geographic coverage area 110. In some examples, control panels 105 may be referred to as a control device, a base transceiver station, a radio base station, an access point, a radio transceiver, or some other suitable terminology. The geographic coverage area 110 for a control panel 105 may be divided into sectors making up only a portion of the coverage area. The communications system 100 may include control panels 105 of different types. There may be overlapping geographic coverage areas 110 for one or more different parameters, including different technologies, features, subscriber preferences, hardware, software, technology, and/or methods. For example, each control panel 105 may be related to one or more discrete structures (e.g., a home, a business) and each of the one more discrete structures may be related to one or more discrete areas. In other examples, multiple control panels 105 may be related to the same one or more discrete structures (e.g., multiple control panels relating to a home and/or a business complex).

The devices 115 are dispersed throughout the communications system 100 and each device 115 may be stationary and/or mobile. A device 115 may include a cellular phone, a personal digital assistant (PDA), a wireless modem, a wireless communication device, a handheld device, a tablet computer, a laptop computer, a cordless phone, a wireless local loop (WLL) station, a display device (e.g., TVs, computer monitors, etc.), a printer, a sensor, and/or the like. A device 115 may also include or be referred to by those skilled in the art as a user device, a sensor, a smartphone, a Bluetooth device, a Wi-Fi device, a mobile station, a subscriber station, a mobile unit, a subscriber unit, a wireless unit, a remote unit, a mobile device, a wireless device, a wireless communications device, a remote device, an access terminal, a mobile terminal, a wireless terminal, a remote terminal, a handset, a user agent, a mobile client, a client, and/or some other suitable terminology. A device 115 may include and/or be one or more sensors that sense: proximity, motion, temperatures, humidity, sound level, smoke, structural features (e.g. glass breaking, window position, door position), time, geo-location data of a user and/or a device, distance, biometrics, weight, speed, height, size, preferences, light, darkness, weather, time, system performance, and/or other inputs that relate to a security and/or an automation system. A device 115 may include one or more sensors proximate one or more barriers to openings to a building. A device 115 may comprise one or more of an actuator, motor, electric motor, and the like. A device 115 may be able to communicate through one or more wired and/or wireless connections with various components such as control panels, base stations, and/or network equipment (e.g., servers, wireless communication points, etc.) and/or the like.

The communication links 125 shown in the communications system 100 may include uplink (UL) transmissions from a device 115 to a control panel 105, and/or downlink (DL) transmissions, from a control panel 105 to a device 115. The downlink transmissions may also be called forward link transmissions while the uplink transmissions may also be called reverse link transmissions. Each communication link 125 may include one or more carriers, where each carrier may be a signal made up of multiple sub-carriers (e.g., waveform signals of different frequencies) modulated according to the various radio technologies. Each modulated signal may be sent on a different sub-carrier and may carry control information (e.g., reference signals, control channels, etc.), overhead information, user data, etc. The communication links 125 may transmit bidirectional communications and/or unidirectional communications. Communication links 125 may include one or more connections, including but not limited to, 345 MHz, Wi-Fi, Bluetooth, cellular, Z Wave, 802.11, peer-to-peer, LAN, WLAN, Ethernet, fire wire, fiber optic, and/or other connection types related to security and/or automation systems.

In some embodiments of the communications system 100, control panels 105 and/or devices 115 may include one or more antennas for employing antenna diversity schemes to improve communication quality and reliability between control panels 105 and devices 115. Additionally or alternatively, control panels 105 and/or devices 115 may employ multiple-input, multiple-output (MIMO) techniques that may take advantage of multi-path, mesh-type environments to transmit multiple spatial layers carrying the same or different coded data.

While the devices 115 may communicate with each other through the control panel 105 using communication links 125, each device 115 may also communicate directly with one or more other devices via one or more direct communication links 134. Two or more devices 115 may communicate via a direct communication link 134 when both devices 115 are in the geographic coverage area 110 or when one or neither devices 115 is within the geographic coverage area 110. Examples of direct communication links 134 may include Wi-Fi Direct, Bluetooth, wired, and/or, and other P2P group connections. The devices 115 in these examples may communicate according to the WLAN radio and baseband protocol including physical and MAC layers from IEEE 802.11, and its various versions including, but not limited to, 802.11b, 802.11g, 802.11a, 802.11n, 802.11ac, 802.11ad, 802.11ah, etc. In other implementations, other peer-to-peer connections and/or ad hoc networks may be implemented within communications system 100.

The sensors 115 may be dispersed through the geographic coverage area 110. The sensors 115 may be located both outside and inside of a building. In some embodiments, the device 115 may comprise an actuator 115 which may be proximate one or more barriers to openings to the building. The barriers may comprise a window, door, porthole, skylight, and the light. In further embodiments, an actuator 115 may additionally be proximate one or more coverings to the barriers. The coverings may comprise shutters, drapes, shades, or the like. The actuators 115 may adjust the barriers to alter the amount of air flow between inside the building and outside the building. The actuators 115 that are proximate the coverings may adjust how much the coverings actually cover the barriers. The coverings may provide additional protection from outdoor conditions, may provide additional insulation to maintain indoor conditions, may allow for privacy, or the like.

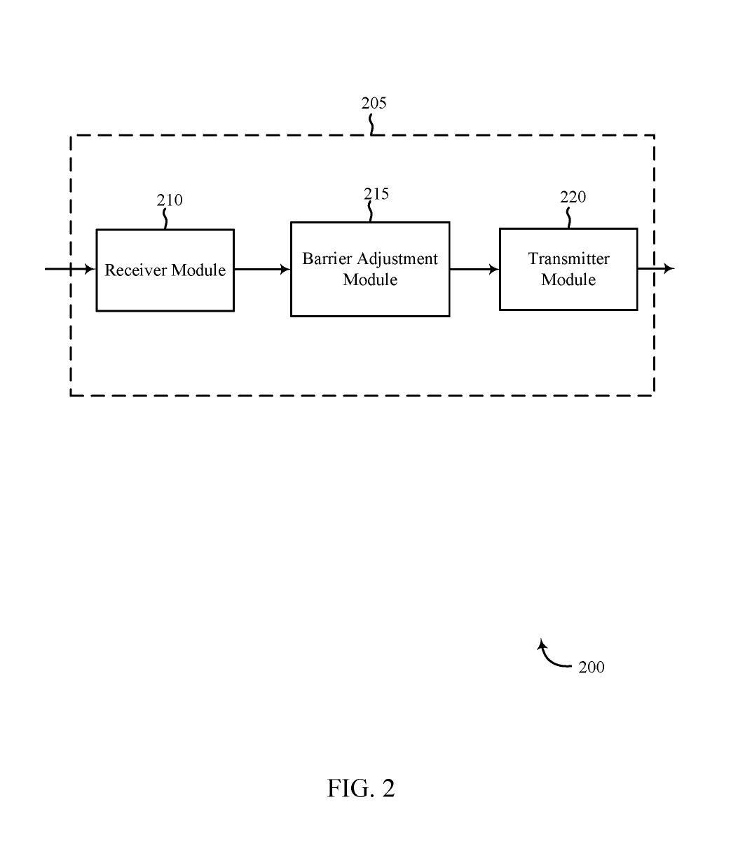

FIG. 2 shows a block diagram 200 of a control panel 205 for use in electronic communication, in accordance with various aspects of this disclosure. The control panel 205 may be an example of one or more aspects of a control panel 105 described with reference to FIG. 1. The control panel 205 may include a receiver module 210, a barrier adjustment module 215, and/or a transmitter module 220. The control panel 205 may also be or include a processor. Each of these modules may be in communication with each other—directly and/or indirectly.

The components of the control panel 205 may, individually or collectively, be implemented using one or more application-specific integrated circuits (ASICs) adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, Field Programmable Gate Arrays (FPGAs), and other Semi-Custom ICs), which may be programmed in any manner known in the art. The functions of each module may also be implemented—in whole or in part—with instructions embodied in memory formatted to be executed by one or more general and/or application-specific processors.

The receiver module 210 may receive information such as packets, user data, and/or control information associated with various information channels (e.g., control channels, data channels, etc.). The receiver module 210 may be configured to receive information from one or more sensors 115. The information may come from one or more indoor and/or outdoor sensors. The information may comprise temperature, wind, wind direction, precipitation, humidity, dryness, temperature, and/or noise level. The information may also comprise time of day and a status of one or more barriers to one or more openings to a building. Information may be passed on to the barrier adjustment module 215, and to other components of the control panel 205.

The barrier adjustment module 215 may generate instructions to adjust one or more barriers on one or more openings in a building. The instructions generated by the barrier adjustment module 215 may attempt to reduce and/or eliminate the use of an HVAC system. By opening and/or closing one or more barriers to the outside of a building, the barrier adjustment module 215 may cause indoor conditions to be improved without the use of energy to power an HVAC system. The barrier adjustment module 215 may implement energy conscious actions to achieve optimal and/or desirable indoor conditions. The barrier adjustment module 215 may alert and/or instruct one or more barriers to an opening to a building to adjust in order to regulate the indoor environmental conditions. The barrier adjustment module 215 may generate instructions that cause the barriers to open or close completely, minimally or some percentage there between to achieve an optimum airflow and the desired indoor conditions, etc.

The transmitter module 220 may transmit the one or more signals received from other components of the control panel 205 The transmitter module 220 may transmit one or more signals to one or more devices proximate at least one barrier to an opening of the building. The signals may comprise instructional information for the barrier to adjust its settings. The signal may be to open or close a barrier and may comprise an amount to open or a length of time to be open or closed. The transmitter module 220 may additionally send a message to a user of the automation system. The message may comprise a variety of information concerning the barrier adjustment module 215. In some examples the transmitter module 220 may be collocated with the receiver module 210 in a transceiver module.

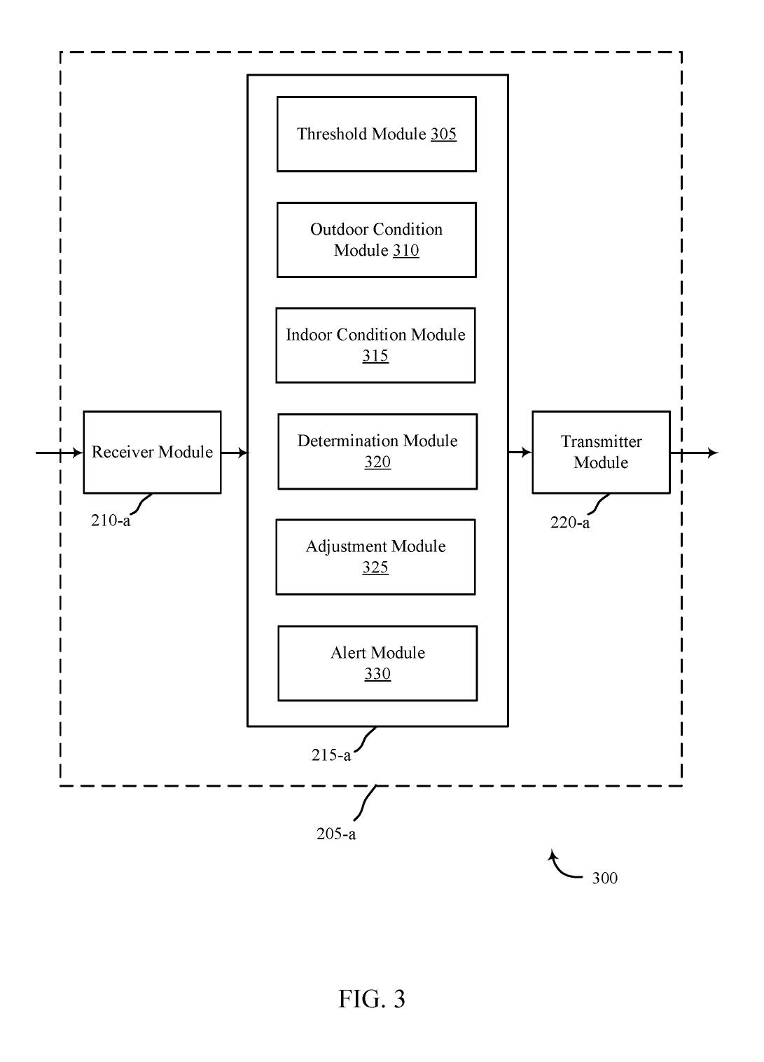

FIG. 3 shows a block diagram 300 of a control panel 205-a for use in wireless communication, in accordance with various examples. The control panel 205-a may be an example of one or more aspects of a control panel 105 described with reference to FIG. 1. It may also be an example of a control panel 205 described with reference to FIG. 2. The control panel 205-a may include a receiver module 210-a, a barrier adjustment module 215-a, and/or a transmitter module 220-a, which may be examples of the corresponding modules of control panel 205. The control panel 205-a may also include a processor. Each of these components may be in communication with each other.

The components of the control panel 205-a may, individually or collectively, be implemented using one or more application-specific integrated circuits (ASICs) adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, Field Programmable Gate Arrays (FPGAs), and other Semi-Custom ICs), which may be programmed in any manner known in the art. The functions of each module may also be implemented—in whole or in part—with instructions embodied in memory formatted to be executed by one or more general and/or application-specific processors.

The barrier adjustment module 215-a may include a threshold module 305, an outdoor condition module 310, an indoor condition module 315, a determination module 320, an adjustment module 325, and an alert module 330. The receiver module 210-a and the transmitter module 220-a may perform the functions of the receiver module 210 and the transmitter module 220 of FIG. 2, respectively.

The threshold module 305 may comprise one or more thresholds to monitor and achieve optimum, desirable indoor conditions. The thresholds may relate to temperature, precipitation, pollution, humidity, safety, noise, dryness, ventilation, smell, smoke, and the like. The thresholds may comprise optimum indoor and outdoor conditions to determine when one or more thresholds may be satisfied. A threshold may comprise a desirable indoor condition matching an outdoor condition. For example, if a user wishes the indoor temperature to be between approximately 65-68 degrees F. and the outdoor temperature is comparable, for example between approximately 64 degrees and 70 degrees F., the threshold may be satisfied.

The threshold module 305 may comprise negative thresholds as well. For example, a threshold may monitor the outdoor pollution levels such as an air quality index, ozone levels, and the like. If a pollution threshold is satisfied, the barrier adjustment module 215-a may not take any action despite the satisfaction of other thresholds. For example, if other thresholds are satisfied to open one or more barriers, but the pollution threshold is also satisfied, the barrier adjustment module 215-a may elect to not open one or more barriers and instead cause one or more barriers to close based on the pollution threshold.

The threshold module 305 may additionally comprise precipitation thresholds. The precipitation thresholds may be based at least in part on an amount of precipitation, a level of precipitation, a time duration of precipitation, and the like. For example, the threshold may request for all barriers to be closed if rainfall becomes heavy or violent. Heavy or violent rainfall may be equivalent to approximately more than 7.6 millimeters per hour for heavy rain or 50 millimeters per hour for violent rain. In contrast, if rainfall is moderate (between approximately 2.5 millimeters of rain per hour and approximately 7.6 millimeters of rain per hour) or if the rainfall is light (approximately less than 2.5 millimeters of rain per hour) and a temperature threshold is satisfied, the combined thresholds may be satisfied and action may be prompted. In some embodiments, the precipitation threshold may request one or more barriers be opened to a predetermined percentage based on the amount of rainfall. For example, if the precipitation is light rain, the threshold may request one or more barriers to be open at least 50% of the way. Likewise, if the precipitation is moderate rainfall, the threshold may request one or more barriers to be open approximately 20%.

The precipitation threshold may additionally comprise thresholds for any type of precipitation including rain, freezing precipitation, frozen precipitation, and the like. Freezing precipitation may comprise freezing drizzle, freezing rain, rain and snow mixed, and the like. Frozen precipitation may comprise snow, snow grains, ice pellets, sleet, hail, snow pellets, ice crystals and the like. In some embodiments, the threshold for freezing precipitation and frozen precipitation may comprise ensuring all barriers are shut and thoroughly insulated. For example, some barriers may have additional indoor and/or outdoor coverings to increase the energy efficiency of the barriers. An example of additional coverings may comprise shutters, drapes, shades, curtains, and the like. Freezing precipitation and frozen precipitation thresholds may be coupled with temperature thresholds. For example, freezing and frozen precipitation typically requires colder temperatures wherein a user may desire upon either threshold being satisfied, for all barriers to a building to be shut.

The threshold module 305 may comprise one or more safety thresholds. A safety threshold may comprise fire, smoke, theft, and the like. For example, if an alert of a robbery, a kidnapping, or similar event occurs either at the building or within a predetermined distance, the safety threshold may require all barriers to the building to be closed and secured. A smoke threshold may operate to close all barriers to a specific room or area of a building where smoke has been detected indoors in an attempt to prevent oxygenating a potential combustible event (e.g. a fire). Additionally, the threshold module 305 may comprise one or more thresholds involving the safety of a building and its contents and inhabitants.

The threshold module 305 may comprise one or more humidity or dryness thresholds. For example, the building may be located in humid or dry area that may require monitoring. For example, the threshold module 305 may comprise a desired level of indoor humidity and/or dryness. This setting may be specific to each user and each geographical location. For example, a user in a dryer environment may wish for a more humid indoor environment which may aid in preventing dryness affecting parts of the body such as skin, nose, throat, and lips. Alternatively, a user in a more humid environment may desire a dryer or less humid environment for various health and well-being concerns. The threshold module 305 may set one or more humidity and/or dryness levels wherein achieving an optimal indoor condition may be accomplished through one or more barrier adjustments to a building.

The threshold module 305 may additionally comprise one or more noise settings. In some embodiments, one or more noise thresholds may be paired with at least a time of day threshold. For example, a user may wish for select times of day to be quiet such as sleeping hours, napping hours for a small child, meditating, meal time, and the like. Additionally, noise over a certain decibel or other sound measure or sound level may be disturbing and/or harmful to occupants of a building. Therefore, if outdoor sounds reach a predetermined threshold, the barrier adjustment module 215-a may act to close all barriers to a home. The predetermined level of disturbance may be set individually or may be based on U.S. Environmental Protection Agency (EPA) regulations of health and safety. In some embodiments, the indoor sound may also have threshold limits similar to outdoor threshold limits. Except, the indoor thresholds may require one or more barriers to open to reduce noise indoors.

The threshold module 305 may additionally comprise smell and/or ventilation thresholds. The smell thresholds may comprise either keeping offensive smells out of a building or airing out and ventilating a building due to an offensive smell indoors. The ventilation threshold may additionally comprise allowing fresh air into a building at select intervals when other thresholds, such as temperature, are satisfied to consistently air out a building.

The threshold module 305 may also additionally comprise an indoor air quality threshold. This may be measured in multiple factors and may relate to health and comfort of building occupants. For example, if a user paints a room inside, the paint may release volatile organic compounds (VOCs). The indoor air quality threshold may set one or more indoor barriers to remain as open as possible until the measure of VOCs reaches an acceptable level. The acceptable level may be user determinable or may be determined using one or more governmental and/or health standards. Other indoor pollutants to measure may comprise second-hand smoke, radon, molds, allergens, carbon monoxide, legionella, bacteria, asbestos, carbon dioxide, ozone, and the like.

The outdoor condition module 310 may monitor one or more outdoor conditions via one or more outdoor sensors. The outdoor condition module 310 may additionally gather information from one or more external sources. For example, one or more geographic coverage areas (e.g. geographic coverage area 110) may comprise one or more outdoor sensors 115. The outdoor sensors 115 may detect one or more of temperature, rain, wind, wind direction, noise, smell, smoke, pollutant, and the like. The outdoor sensors may additionally be specific to a side or area of a building. For example, a wind and wind direction sensor may be proximate a north, west, east, and south side of a building. All sensors may have one or more types surrounding the building to adequately measure conditions as they vary around a geographic coverage area.

The indoor condition module 315 may monitor one or more indoor conditions via one or more indoor sensors. The one or more indoor sensors may be proximate any room or within a predetermined distance of an opening to a building. Multiple sensors may be present in a room to detect one or more conditions in relation to one or more thresholds. Some sensors may be combination sensors and able to detect one or more conditions.

The determination module 320 may collect information from the outdoor condition module 310 and/or the indoor condition module 315 to determine whether to take action and which actions to take. For example, the determination module 320 may analyze the information from the outdoor condition module 310 and/or the indoor condition module 315 to determine if one or more thresholds have been satisfied. Depending on the thresholds and the information, the determination module 320 may conclude which barriers to instruct to alter, when to alter the barriers, how much or which percentage the barriers should be altered and the like. For example, if the user has an indoor temperature threshold and the outdoor temperature will assist in achieving the threshold if one or more windows is opened, the determination module 320 may decide which windows to instruct to open to allow for optimum air flow and to achieve the indoor temperature. Additionally, the determination module 320 may approximate how long it will take to reach the desired indoor conditions and may adjust one or more windows or other barriers as necessary to achieve the desired threshold.

The adjustment module 325 may communicate with one or more actuators or other window and/or barrier adjustment sensors and/or apparatus. The adjustment module 325 may transmit information regarding the percentage of change to occur. For example, “open barrier approximately 20%”, “shut barrier”, “open barrier 100%”, and the like. In some instances, the adjustment module 325 may monitor one or more conditions of a barrier to determine how to achieve the adjustments requested by the determination module 320. For example, if a barrier is already open but requires adjustment, the adjustment module 325 may calculate the difference between the request to achieve the conditions set forth in the determination module 320. In some instances, the adjustment module 325 may adjust one or more coverings for a barrier. For example, a barrier may have shutters, blinds, curtains, and the like. The adjustment module 325 may determine that shutting one or more of the coverings may prevent a building from heating up or may retain more heat in colder environments.

The alert module 330 may transmit one or more alerts to a user of an automation system or other personnel or safety official. The alerts may comprise one or more messages regarding the status of one or more barriers to a building. The alerts may additionally comprise status changes, threshold satisfaction alerts, override requests, safety alerts, and the like. The messages may comprise a display on the control panel 205-a, a text message, a pin message an SMS, an email, a phone call, a voice message, and the like. In some embodiments, if one or more safety thresholds are satisfied, the alert module 330 may additionally contact on or more safety personnel. For example, the alert module 330 may contact the police for a robbery or the fire department for a fire.

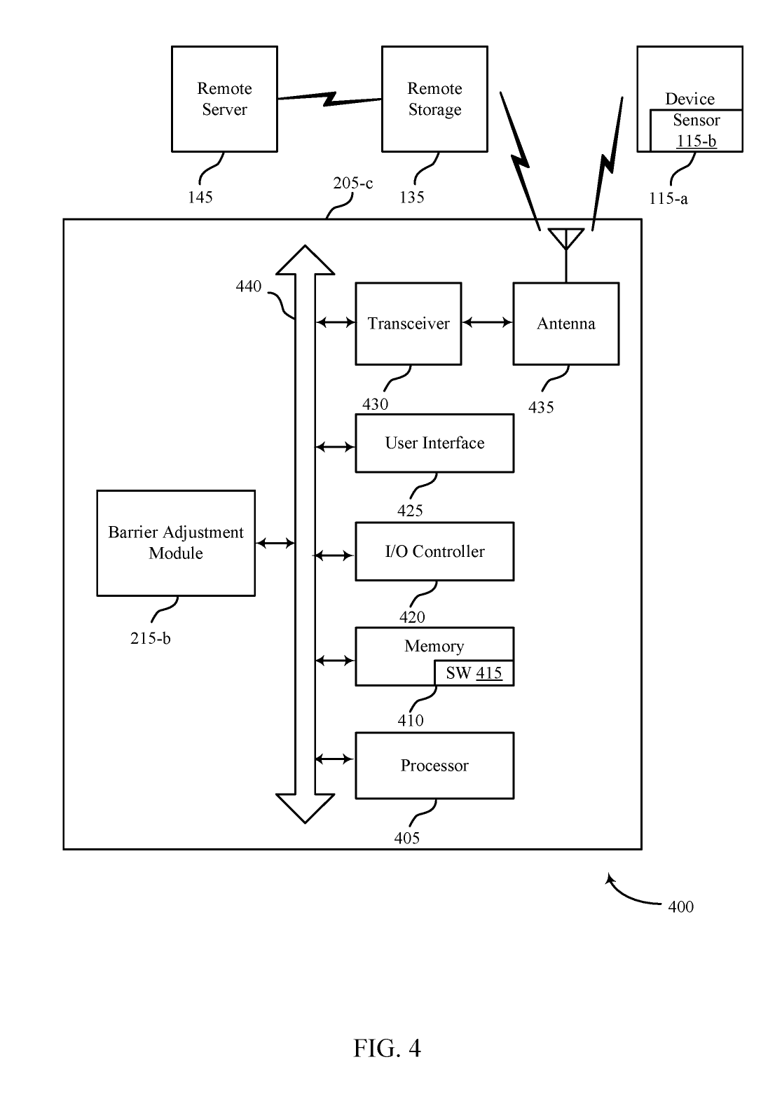

FIG. 4 shows a system 400 for use in energy efficient management of indoor conditions and systems, in accordance with various examples. System 400 may include a control panel 205-c, which may be an example of the control panels 105 of FIG. 1. The control panel 205-c may also be an example of one or more aspects of control panels 205 and/or 205-a of FIGS. 2 and 3.

Control panel 205-c may include barrier adjustment module 215-b, which may be an example of barrier adjustment module 215 described with reference to FIGS. 2 and/or 3. In some embodiments the terms a control panel and a control device are used synonymously.

Control panel 205-c may also include components for bi-directional voice and data communications including components for transmitting communications and components for receiving communications. For example control panel 205-c may communicate bi-directionally with one or more of device 115-a, one or more sensors 115-b, remote storage 135, and/or remote server 145. This bi-directional communication may be direct (e.g., control panel 205-c communicating directly with remote storage 135) or indirect (e.g., control panel 205-c communicating indirectly with remote server 145 through remote storage 135).

The barrier adjustment module 215-b may instruct one or more barriers to openings in a building to adjust based at least in part on one or more thresholds as described above with reference to FIG. 3. For example, the barrier adjustment module 215-b may link a control panel 205-c to actuators, sensors, weather information, and the like. The barrier adjustment module 215-b may track the conditions and pending changes to facilitate an energy efficient building. For example, the barrier adjustment module 215-b may alert a user of the automation system when to open or close building barriers to facilitate a more comfortable indoor experience. For example, a user may be instructed that opening a window may alter the indoor temperature to a more comfortable setting. The window may be a specific window or may be a generic window. In some embodiments, the user may receive specific information pertaining to rooms, windows, indoor conditions, and the like. For example, the user may be instructed that a particular room is overheated but opening the two south facing windows would reduce the temperature to a comfortable level within thirty minutes without the use of electricity or an HVAC system. If the user is at the location, the user may take action to open the specific windows. The user may additionally have the option of instructing the automation system to open the windows remotely.

In another embodiment, the barrier adjustment module 215-b may automatically open windows and/or barriers to achieve a more comfortable indoor environment independent of user input. If the windows, or other openings, are scheduled to be automatically opened, the programming may have additional safety features. For example, a commercial building may not wish to have all of the windows open at night if no one is on the premise or if very few people are the premises. Likewise, a homeowner may not wish for windows to open while the house is unoccupied or while the occupants are sleeping or otherwise engaged. In other embodiments, only specific windows may be programmed to be opened based on security or other concerns. For example, a commercial location may have additional security features affixed to building openings such as bars, or the like. The commercial user may enable the system to open those windows despite an occupancy count. Similarly, a home automation user may be comfortable with second story or specific windows being home based on occupancy or alertness of occupants.

Control panel 205-c may also include a processor module 405, a memory 410 (including software (SW) 415), an input/output controller module 420, a user interface module 425, a transceiver module 430, and one or more antennas 435 each of which may communicate—directly or indirectly—with one another (e.g., via one or more buses 440). The transceiver module 430 may communicate bi-directionally—via the one or more antennas 435, wired links, and/or wireless links—with one or more networks or remote devices as described above. For example, the transceiver module 430 may communicate bi-directionally with one or more of device 115-a, remote storage 135, and/or remote server 145. The transceiver module 430 may include a modem to modulate the packets and provide the modulated packets to the one or more antennas 435 for transmission, and to demodulate packets received from the one or more antenna 435. While a control panel or a control device (e.g., 205-c) may include a single antenna 435, the control panel or the control device may also have multiple antennas 435 capable of concurrently transmitting or receiving multiple wired and/or wireless transmissions. In some embodiments, one element of control panel 205-c (e.g., one or more antennas 435, transceiver module 430, etc.) may provide a direct connection to a remote server 145 via a direct network link to the Internet via a POP (point of presence). In some embodiments, one element of control panel 205-c (e.g., one or more antennas 435, transceiver module 430, etc.) may provide a connection using wireless techniques, including digital cellular telephone connection, Cellular Digital Packet Data (CDPD) connection, digital satellite data connection, and/or another connection.

The signals associated with system 400 may include wireless communication signals such as radio frequency, electromagnetics, local area network (LAN), wide area network (WAN), virtual private network (VPN), wireless network (using 802.11, for example), 345 MHz, Z Wave, cellular network (using 3G and/or LTE, for example), and/or other signals. The one or more antennas 435 and/or transceiver module 430 may include or be related to, but are not limited to, WWAN (GSM, CDMA, and WCDMA), WLAN (including Bluetooth and Wi-Fi), WMAN (WiMAX), antennas for mobile communications, antennas for Wireless Personal Area Network (WPAN) applications (including RFID and UWB). In some embodiments, each antenna 435 may receive signals or information specific and/or exclusive to itself. In other embodiments, each antenna 435 may receive signals or information neither specific nor exclusive to itself.

In some embodiments, one or more sensors 115-b (e.g., motion, proximity sensor, smoke, glass break, door, window, carbon monoxide, and/or another sensor) may connect to some element of system 400 via a network using one or more wired and/or wireless connections.

In some embodiments, the user interface module 425 may include an audio device, such as an external speaker system, an external display device such as a display screen, and/or an input device (e.g., remote control device interfaced with the user interface module 425 directly and/or through I/O controller 420).

One or more buses 440 may allow data communication between one or more elements of control panel 205-c (e.g., processor module 405, memory 410, I/O controller module 420, user interface module 425, etc.).

The memory 410 may include random access memory (RAM), read only memory (ROM), flash RAM, and/or other types. The memory 410 may store computer-readable, computer-executable software/firmware code 415 including instructions that, when executed, cause the processor module 405 to perform various functions described in this disclosure (e.g., open or close one or more barriers to a building, track one or more indoor and outdoor environmental conditions, review pending weather alerts and other safety bulletins, etc.). Alternatively, the software/firmware code 415 may not be directly executable by the processor module 405 but may cause a computer (e.g., when compiled and executed) to perform functions described herein.

In some embodiments, the processor module 405 may include, among other things, an intelligent hardware device (e.g., a central processing unit (CPU), a microcontroller, and/or an ASIC, etc.). The memory 410 can contain, among other things, the Basic Input-Output system (BIOS) which may control basic hardware and/or software operation such as the interaction with peripheral components or devices. For example, the barrier adjustment module 215-b to implement the present systems and methods may be stored within the system memory 410. Applications resident with system 400 are generally stored on and accessed via a non-transitory computer readable medium, such as a hard disk drive or other storage medium. Additionally, applications can be in the form of electronic signals modulated in accordance with the application and data communication technology when accessed via a network interface (e.g., transceiver module 430, one or more antennas 435, etc.).

Many other devices and/or subsystems may be connected to one or may be included as one or more elements of system 400 (e.g., entertainment system, computing device, remote cameras, wireless key fob, wall mounted user interface device, cell radio module, battery, alarm siren, door lock, lighting system, thermostat, home appliance monitor, utility equipment monitor, and so on). In some embodiments all of the elements shown in FIG. 4 need not be present to practice the present systems and methods. The devices and subsystems can be interconnected in different ways from that shown in FIG. 4. In some embodiments, an aspect of some operation of a system, such as that shown in FIG. 4, may be readily known in the art and are not discussed in detail in this application. Code to implement the present disclosure can be stored in a non-transitory computer-readable medium such as one or more of system memory 410 or other memory. The operating system provided on I/O controller module 420 may be iOS®, ANDROID®, MS-dOS®, MS-WINDOWS®, OS/2®, UNIX®, LINUX®, or another known operating system.

The transceiver module 430 may include a modem configured to modulate the packets and provide the modulated packets to the antennas 435 for transmission and/or to demodulate packets received from the antennas 435. While the devices 115-a may include a single antenna 435, the devices 115-a may have multiple antennas 435 capable of concurrently transmitting and/or receiving multiple wireless transmissions.

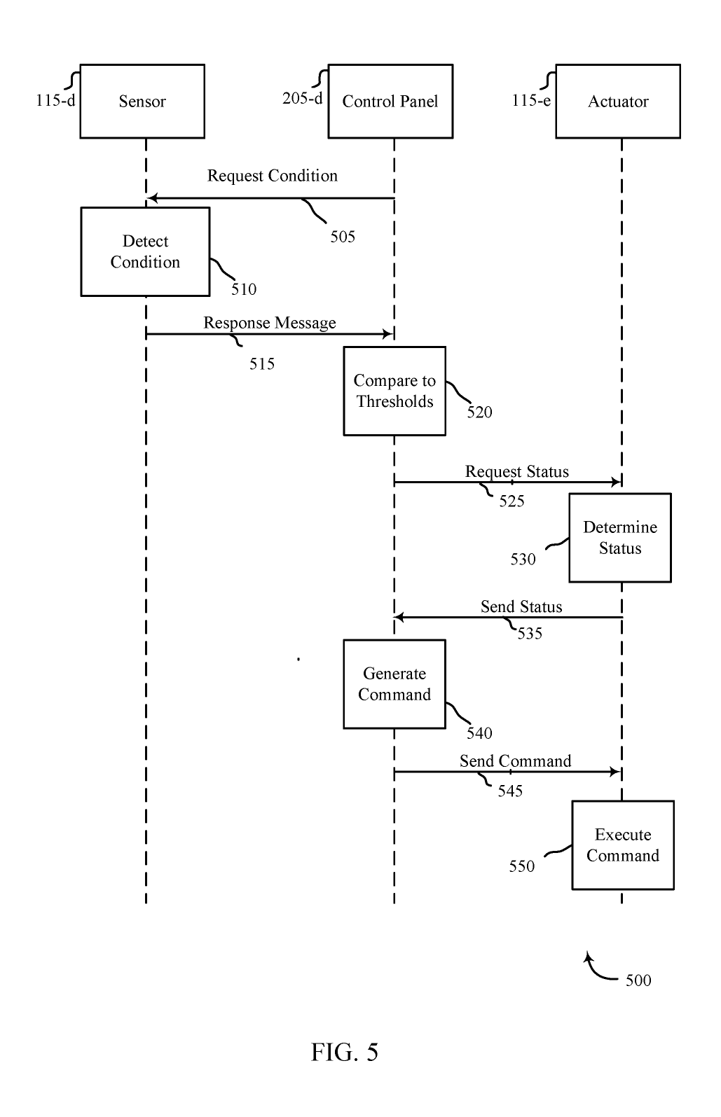

FIG. 5 shows a swim diagram 500 illustrating communications in an efficient environmental management system, in accordance with various examples. The diagram 500 illustrates one or more devices 115-d, 115-e which may be an example of the device 115 of FIG. 1. The diagram 500 also illustrates a control panel 205-d which may an example of control panel 105 of FIG. 1 and/or an example of one or more aspects of control panels 205 and/or 205-a of FIGS. 2 and 3.

The first device 115-d may be referred to as a sensor. The second device 115-e may be an actuator. The control panel 205-d may request a condition 505 from the sensor 115-d. The condition may be relevant to the particular sensor. For example, specific sensors may detect specific conditions such as temperature, wind speed, pollution, noise, and the like. The sensor 115-d may detect the condition 510 and send the control panel 205-d a response message 515. The response message 515 may comprise the current conditions at a location proximate the sensor 115-d.

The control panel 205-d may compare the condition to one or more thresholds 520. The control panel 205-d may request condition information from multiple sensors both inside and outside of a building to properly compare thresholds 520. The control panel 205-d may then request one or more statuses 525 from one or more actuators 115-e proximate one or more barriers to the building. The actuator 115-e may determine the status of the barrier and send the status 535 to the control panel 205-d. The status may comprise a percentage the barrier is open, if the barrier is closed or the like. The control panel 205-d may use the status and the condition to generate a command 540. The command may comprise one of more adjustments for the actuator 115-e to carry out. The control panel 205-d may send the command 545 to the actuator 115-e. The actuator 115-e may execute the command 550. Adjusting the barrier may enable a more efficient management of indoor environmental conditions and increase the user's comfort while in the building.

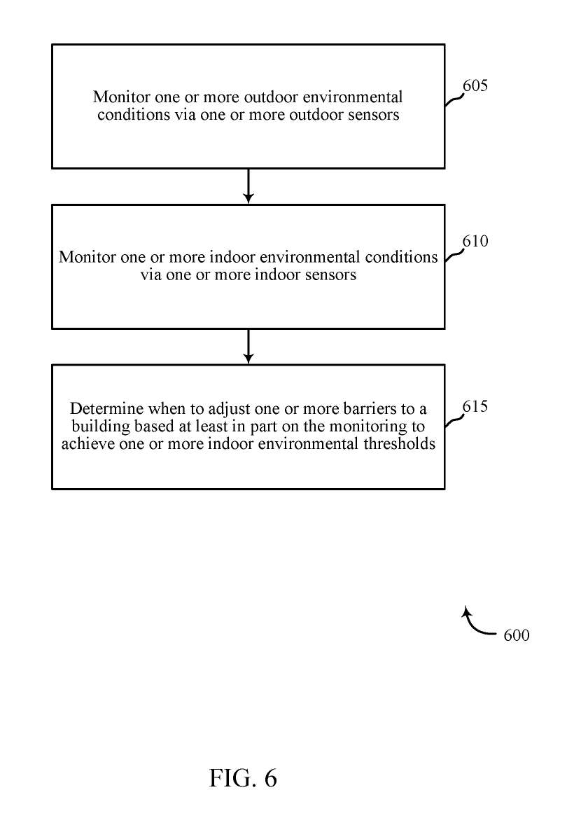

FIG. 6 is a flow chart illustrating an example of a method 600 for efficiently managing indoor conditions in accordance with various aspects of the present disclosure. For clarity, the method 600 is described below with reference to aspects of one or more of the barrier adjustment module 215 described with reference to FIGS. 2, 3, 4, and/or 5, and/or aspects of one or more of the system 100 described with reference to FIG. 1. In some examples, a control panel 105 may execute one or more sets of codes to control the functional elements of the control panel 105 to perform the functions described below. Additionally or alternatively, control panel 105 may perform one or more of the functions described below using special-purpose hardware.

At block 605, the method 600 may include monitoring one or more outdoor environmental conditions via one or more outdoor sensors. The outdoor sensors may be outside of a building in a geographic coverage area of an automation system. The sensors may track one or more relevant environmental conditions. The outdoor environmental conditions may comprise temperature, wind, light, precipitation, noise, pollution, wind direction, and the like. The sensors may be dispersed throughout the geographic coverage area to determine if any differences exist around a perimeter of the building. For example, conditions on a north and a south side of the building may be different. The sensors may be individual sensors or may be combination sensors. The sensors may collect information and transmit the information back to a control panel associated with the automation system.

The operation(s) at block 605 may be performed using the outdoor condition module 310 described with reference to FIG. 3.

At block 610, the method 600 may include monitoring one or more indoor environmental conditions via one or more indoor sensors. The indoor sensors may be inside a building. Specifically, the indoor sensors may be in every room in a building, or depending on the size of a room, multiple sensors may be strategically placed throughout a room to detect changing conditions. A residence may only have the minimum set of sensors in each room but a commercial warehouse may have multiple sets and types of sensors scattered throughout the warehouse. The sensors may collect and transmit various environmental conditions to the control panel associated with the automation system.

The operation(s) at block 610 may be performed using the indoor condition module 315 described with reference to FIG. 3.

At block 615, the method 600 may include determining when to adjust one or more barriers to a building based at least in part on the monitoring to achieve one or more indoor environmental thresholds. For example, the outdoor and indoor environmental conditions may be gathered, analyzed, and compared to one or more thresholds. Depending upon various factors and thresholds, one or more barriers may be adjusted to achieve optimum indoor environmental conditions. At block 615, the determination may be made as to which barriers to adjust, how much adjustment should take place, potential energy savings, and approximately how long adjustments should remain in place.

The operation(s) at block 615 may be performed using the determination module 320 described with reference to FIG. 3.

Thus, the method 600 may provide for efficient management of indoor conditions relating to automation/security systems. It should be noted that the method 600 is just one implementation and that the operations of the method 600 may be rearranged or otherwise modified such that other implementations are possible.

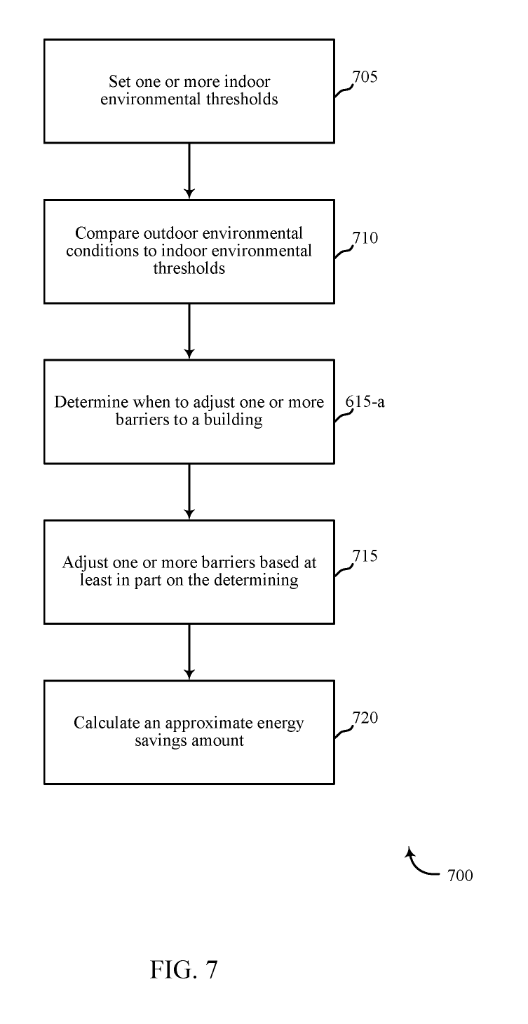

FIG. 7 is a flow chart illustrating an example of a method 700 for efficiently managing indoor conditions in accordance with various aspects of the present disclosure. For clarity, the method 700 is described below with reference to aspects of one or more of the barrier adjustment module 215 described with reference to FIGS. 2, 3, 4, and/or 5, and/or aspects of one or more of the system 100 described with reference to FIG. 1. In some examples, a control panel 105 may execute one or more sets of codes to control the functional elements of the control panel to perform the functions described below. Additionally or alternatively, control panel may perform one or more of the functions described below using special-purpose hardware.

At block 705, the method 700 may include setting one or more indoor environmental thresholds. The indoor environmental thresholds may comprise desirable indoor conditions. The thresholds may relate to temperature, noise level, ventilation, safety, comfort, and the like. The thresholds may additionally be weighted such that certain thresholds may have great importance more than others may. For example, an indoor air quality threshold may take precedence over all other thresholds. Additionally, an outdoor pollution threshold may negate one or more other thresholds. For example, a user may not want a window opened if the pollution outside has reached potentially harmful conditions according to governmental regulations or user preferences.

The operation(s) at block 705 may be performed using the threshold module 305 described with reference to FIG. 3.

At block 710, the method 700 may include comparing outdoor environmental conditions to indoor environmental thresholds. The indoor environmental thresholds may be achieved by opening one or more barriers to a building rather than using an HVAC system. If one or more outdoor environmental conditions satisfies one or more indoor conditions, then at block 615-a, it may be determined when to adjust one or more barriers to a building to achieve one or more indoor environmental conditions.

The operation(s) at block 710 and 615-a may be performed using the determination module 320 described with reference to FIG. 3.

At block 715, the method 700 may include adjusting a barrier to an opening of a building based at least in part on the determining. The adjustment may be minimal or may be substantive. For example, a window may open 5% or 95%. The amount of the adjustment may depend on a variety of factors including temperature differentials, how quickly an adjustment should take place, if there is any wind, and the like. The adjustments may be recorded and a user of an automation system may receive one or more reports comprising changes to the barriers.

The operation(s) at block 715 may be performed using the adjustment module 325 described with reference to FIG. 3.

At block 720, the method 700 may include calculating an approximate energy savings amount. For example, adjusting one or more barriers to a home to achieve optimum indoor environmental conditions may reduce and/or eliminate the use of an HVAC system for a period of time. The method 700 may approximate the cost of running the HVAC equipment and calculate a total approximate savings by not using the HVAC system. The approximate savings may be sent to a user of an automation system to display an approximate savings amount and/or may be stored in a server or other location for future reference.

In some examples, aspects from two or more of the methods 600, 700 may be combined and/or separated. It should be noted that the methods 600, 700, are just example implementations, and that the operations of the methods 600, 700 may be rearranged or otherwise modified such that other implementations are possible.

The detailed description set forth above in connection with the appended drawings describes examples and does not represent the only instances that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with this disclosure may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, and/or state machine. A processor may also be implemented as a combination of computing devices, e.g., a combination of a DSP and a microprocessor, multiple microprocessors, one or more microprocessors in conjunction with a DSP core, and/or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physic al locations.

As used herein, including in the claims, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

In addition, any disclosure of components contained within other components or separate from other components should be considered exemplary because multiple other architectures may potentially be implemented to achieve the same functionality, including incorporating all, most, and/or some elements as part of one or more unitary structures and/or separate structures.

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM, DVD, or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed.

This disclosure may specifically apply to security system applications. This disclosure may specifically apply to automation system applications. In some embodiments, the concepts, the technical descriptions, the features, the methods, the ideas, and/or the descriptions may specifically apply to security and/or automation system applications. Distinct advantages of such systems for these specific applications are apparent from this disclosure.

The process parameters, actions, and steps described and/or illustrated in this disclosure are given by way of example only and can be varied as desired. For example, while the steps illustrated and/or described may be shown or discussed in a particular order, these steps do not necessarily need to be performed in the order illustrated or discussed. The various exemplary methods described and/or illustrated here may also omit one or more of the steps described or illustrated here or include additional steps in addition to those disclosed.

Furthermore, while various embodiments have been described and/or illustrated here in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments these software modules may permit and/or instruct a computing system to perform one or more of the exemplary embodiments disclosed here.

This description, for purposes of explanation, has been described with reference to specific embodiments. The illustrative discussions above, however, are not intended to be exhaustive or limit the present systems and methods to the precise forms discussed. Many modifications and variations are possible in view of the above teachings. The embodiments were chosen and described in order to explain the principles of the present systems and methods and their practical applications, to enable others skilled in the art to utilize the present systems, apparatus, and methods and various embodiments with various modifications as may be suited to the particular use contemplated.

What is claimed is:

1. A method for security and/or automation systems, comprising:
monitoring one or more outdoor environmental conditions via one or more outdoor sensors;
monitoring one or more indoor environmental conditions via one or more indoor sensors; and
determining when to adjust one or more barriers to a building based at least in part on the monitoring to achieve one or more indoor environmental thresholds.

2. The method of claim 1, further comprising:
adjusting the one or more barriers to the building based at least in part on the determining.

3. The method of claim 2, further comprising:
alerting a user of an automation system to adjust one or more HVAC settings based at least in part on the determining and the adjusting.

4. The method of claim 2, further comprising:
calculating an approximate energy savings based at least in part on the adjusting.

5. The method of claim 1, further comprising:
notifying a user of an automation system to adjust the one or more barriers to the building based at least in part on the determining.

6. The method of claim 5, wherein a notification comprises energy saving information.

7. The method of claim 1, further comprising:
adjusting one or more barrier coverings based at least in part on the determining.

8. The method of claim 1, wherein the one or more outdoor environmental conditions comprises one of at least temperature, wind speed, wind direction, air quality, humidity, precipitation, and noise.

9. The method of claim 8, further comprising:
determining if the air quality or the noise satisfy one or more thresholds; and
closing the one or more barriers to the building based on the determining.

10. The method of claim 1, wherein the one or more outdoor environmental conditions each have a threshold to satisfy to either open or close the one or more barriers.

11. The method of claim 10, wherein each indoor environmental condition and outdoor environmental condition is weighted and the threshold for a highest weighted indoor or outdoor environmental condition takes precedent over a lower weighted indoor or outdoor environmental condition.

12. The method of claim 1, further comprising:
calculating a length of time to achieve a desired indoor environmental condition based at least in part on the monitoring; and
gauging an approximate energy savings based at least in part on the calculating.

13. An apparatus for security and/or automation systems, comprising:
a processor;
memory in electronic communication with the processor; and
instructions stored in the memory, the instructions being executable by the processor to:
monitor one or more outdoor environmental conditions via one or more outdoor sensors;
monitor one or more indoor environmental conditions via one or more indoor sensors; and
determine when to adjust one or more barriers to a building based at least in part on the monitoring to achieve one or more indoor environmental thresholds.

14. The apparatus of claim 13, the instructions further executable to:
adjust the one or more barriers to the building based at least in part on the determining.

15. The apparatus of claim 13, the instructions further executable to:
notify a user of an automation system to adjust the one or more barriers to the building based at least in part on the determining.

16. The apparatus of claim 13, the instructions further executable to:
adjust one or more barrier coverings based at least in part on the determining.

17. A non-transitory computer-readable medium storing computer-executable code for security and/or automation systems, the code executable by a processor to:
monitor one or more outdoor environmental conditions via one or more outdoor sensors;
monitor one or more indoor environmental conditions via one or more indoor sensors; and
determine when to adjust one or more barriers to a building based at least in part on the monitoring to achieve one or more indoor environmental thresholds.

18. The non-transitory computer-readable medium of claim 17, the code further executable to:
adjust the one or more barriers to the building based at least in part on the determining.

19. The non-transitory computer-readable medium of claim 17, the code further executable to:
notify a user of an automation system to adjust the one or more barriers to the building based at least in part on the determining.

20. The non-transitory computer-readable medium of claim 17, the code further executable to:
adjust one or more barrier coverings based at least in part on the determining.
